(19) United States
(12) Patent Application Publication
(10) Pub. No.: US 2019/0345299 A1
(43) Pub. Date: Nov. 14, 2019

(54) METHOD OF USING PRE-PREG FILM FOR PRODUCING CARBON FIBER PARTS

(71) Applicant: GM GLOBAL TECHNOLOGY OPERATIONS LLC, DETROIT, MI (US)

(72) Inventor: Bradley J. Tice, Clarkston, MI (US)

(21) Appl. No.: 15/975,200

(22) Filed: May 9, 2018

(51) Int. Cl. C08J 5/04; C08J 5/24; B32B 27/12

(52) U.S. Cl. CPC C08J 5/042; C08J 5/24; B32B 27/12; C08J 2431/00; B32B 2307/71; C08J 2427/12; C08J 2375/04; B32B 2260/021

(57) ABSTRACT

A method of using clear UV protective film for producing a pre-preg carbon fiber part includes pre-applying a clear UV protective film to at least one of a top and bottom surface of a pre-preg carbon fiber workpiece, and placing the pre-preg carbon fiber workpiece between an upper mold portion and a lower mold portion of a hot press molding apparatus. Next, the method includes compressing the pre-preg carbon fiber workpiece between the upper and lower portions of the hot press molding apparatus to form a pre-preg carbon fiber part, and holding the pre-preg carbon fiber part in the hot press molding apparatus until the pre-applied clear UV protective film and the pre-preg carbon fiber part have cured.

### TECHNICAL FIELD

The present disclosure relates to a method of producing a fiber reinforced composite part and, more particularly, to a method of using clear ultra violet (UV) protective film for producing a pre-preg carbon fiber part.

### BACKGROUND

In molding a thermoplastic FRP part (fiber reinforced plastic) from laminated sheets of pre-preg formed of woven fiber fabric, such as woven carbon-fiber fabric (CFRP, carbon fiber reinforced plastic), impregnated with thermoset or thermoplastic resin as a matrix, a molding method using an autoclave is known. Recently, as an alternative to the molding method using an autoclave, a hot press molding method using a molding apparatus is being developed.

An example of the molding method for use in hot press molding as illustrated in FIG. 1 includes providing a lower mold (first mold) 14 and an upper mold (second mold) 16 which is brought nearer to or away from the lower mold 14. The upper mold 16 has a core projecting downward, and the lower mold 14 has a cavity open upward.

In molding with this molding apparatus, in a mold open state, laminated sheets of carbon fiber pre-preg material 12 are set in the cavity in the lower mold 14. Then, the upper mold 16 is moved down so that the carbon fiber pre-preg material 12 is clamped between the core of the upper mold 16 and the cavity of the lower mold 14. In this state, heating is conducted while pressure is applied to the carbon fiber pre-preg material 12 with the resin matrix melted, by the upper 16 and lower molds 14.

After the application of pressure, the resin matrix is cured by being cooled through the upper 16 and lower molds 14. Consequently, a CFRP part of varying shape is obtained. Thereafter, the part is sprayed 18 with an expensive clear coat material to provide a smooth esthetic appearance as well as ultraviolet (UV) protection. In some cases, multiple coats of the finishing material are required to obtain the desired smooth surface and UV protection which leads to increased costs for producing the part.

### SUMMARY

One or more exemplary embodiments described herein provide a method of using clear ultra violet (UV) protective film for producing a pre-preg carbon fiber part.

In accordance with aspects of an exemplary embodiment, the method of using clear ultra violet (UV) protective film for producing a pre-preg carbon fiber part includes pre-applying a clear UV protective film to at least one of a top and bottom surface of a pre-preg carbon fiber workpiece. Another aspect includes placing the pre-preg carbon fiber workpiece between an upper mold portion and a lower mold portion of a hot press molding apparatus. And another aspect includes compressing the pre-preg carbon fiber workpiece between the upper and lower portions of the hot press molding apparatus to form a pre-preg carbon fiber part. And still another aspect includes holding the pre-preg carbon fiber part in the hot press molding apparatus until the pre-applied clear UV protective film and the pre-preg carbon fiber part have cured.

A further aspect in accordance with the exemplary embodiment wherein the clear UV protective film is urethane based. An alternative aspect wherein the clear UV protective film is ionomer based. Another alternative aspect wherein the clear UV protective film is fluoropolymer based. And yet another alternative wherein the clear UV protective film is polycarbonate based.

Still another aspect in accordance with an exemplary embodiment wherein the pre-preg carbon fiber part is a Class A surface part. And another aspect wherein the pre-preg carbon fiber workpiece is a dry lay up workpiece. Yet another aspect wherein the pre-preg carbon fiber workpiece is a wet lay up workpiece. And one other aspect in accordance with an exemplary embodiment includes removing the pre-preg carbon fiber part from the hot press molding apparatus after curing is complete.

The detailed description and the drawings or Figures are supportive and descriptive of the disclosure, but the claim scope of the disclosure is defined solely by the claims. While some of the best modes and other embodiments for carrying out the claims have been described in detail, various alternative designs and embodiments exist for practicing the disclosure defined in the appended claims.

### BRIEF DESCRIPTION OF THE DRAWINGS

FIG. 1 is an illustration of a prior art method for hot press molding of a part formed from carbon fiber pre-preg material.

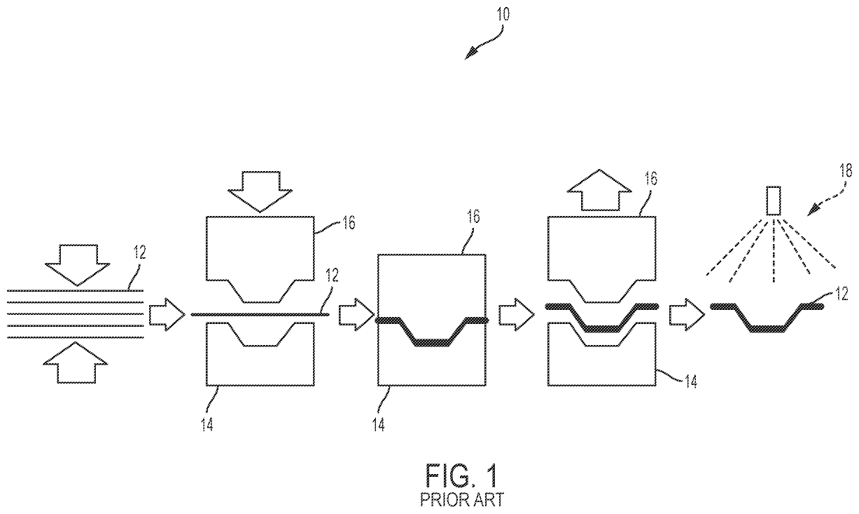

FIG. 2 is an illustration of a method of using clear ultra violet (UV) protective film for producing a pre-preg carbon fiber part in accordance with an exemplary embodiment.

FIG. 3 is an algorithm for the method of using clear ultra violet (UV) protective film for producing a pre-preg carbon fiber part in accordance with an exemplary embodiment.

### DETAILED DESCRIPTION

Those having ordinary skill in the art will recognize that all directional references (e.g., above, below, upward, up, downward, down, top, bottom, left, right, vertical, horizontal, etc.) are used descriptively for the figures to aid the reader's understanding, and do not represent limitations (for example, to the position, orientation, or use, etc.) on the scope of the disclosure, as defined by the appended claims.

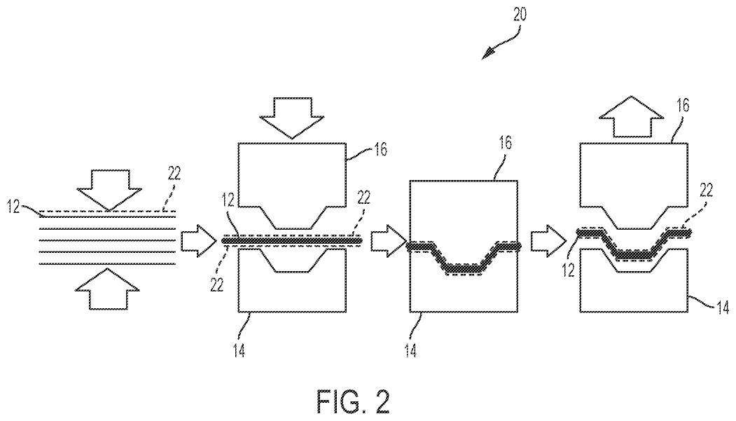

Referring to FIG. 2, an illustration of a method 20 of using clear ultra violet (UV) protective film for producing a pre-preg carbon fiber Class A surface part in accordance with an exemplary embodiment is provided. Class A surfaces refer to surfaces that present a smooth looking reflective appearance and have curvature and tangency alignment. Generally, the method includes pre-applying a clear UV protective film 22 to at least one of a top and bottom surface of a pre-preg carbon fiber workpiece 12. The pre-preg carbon fiber workpiece 12 may be a wet or dry lay up pre-preg carbon fiber workpiece, and the ultra violet protective film 22 may be one of, but not limited to, a urethane, an ionomer, a fluoropolymer, or a polycarbonate based film.

After the UV protective film 22 is applied to at least one of the top or bottom surfaces of the pre-preg carbon fiber workpiece 12, the workpiece is placed between the lower 14 and upper 16 molds of the hot press molding apparatus. Then, the upper mold 16 is moved down so that the pre-preg carbon fiber material 12 is clamped between the core of the upper mold 16 and the cavity of the lower mold 14. In this state, heating is conducted while pressure is applied to the pre-preg carbon fiber material 12 with the resin matrix (not shown) and the UV protective film 22 melted, by the upper 16 and lower molds 14.

After the application of pressure, the resin matrix and UV protective film 22 is cured by being cooled through the upper 16 and lower molds 14. Consequently, a CFRP Class A part of varying shape is obtained. Accordingly, the method of using clear ultra violet (UV) protective film for producing a pre-preg carbon fiber Class A surface part in accordance with an exemplary embodiment eliminates the need for applying the expensive clear coat material to the molded workpiece after the part is removed from the molding apparatus.

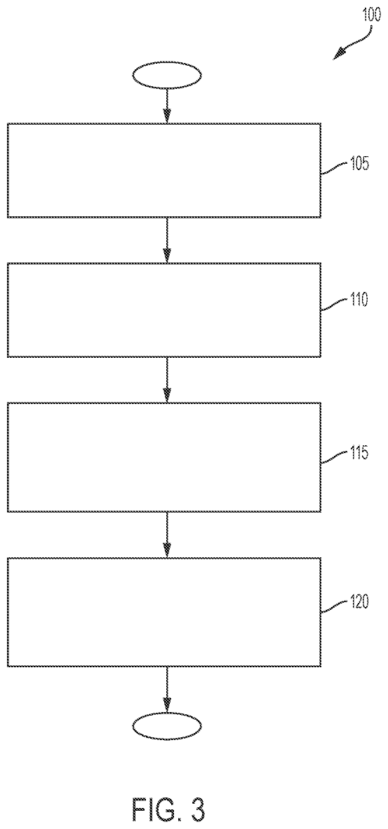

Referring now to FIG. 3, an algorithm for the method of using clear ultra violet (UV) protective film for producing a pre-preg carbon fiber part in accordance with an exemplary embodiment is provided. The method 100 begins at block 105 with pre-applying a clear UV protective film to at least one of a top and bottom surface of a pre-preg carbon fiber workpiece. At block 110, the method continues with placing the pre-preg carbon fiber workpiece between an upper mold portion and a lower mold portion of a hot press molding apparatus. Next, at block 115, the method continues with compressing the pre-preg carbon fiber workpiece between the upper and lower portions of the hot press molding apparatus to form a pre-preg carbon fiber part. And, at block 120, the method finishes with holding the pre-preg carbon fiber part in the hot press molding apparatus until the pre-applied clear UV protective film and the pre-preg carbon fiber part have cured and then removing the molded part from the molding apparatus.

While the best modes and other embodiments for carrying out the disclosure have been described in detail, those familiar with the art to which this disclosure relates will recognize various alternative designs and embodiments for practicing the disclosure within the scope of the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment can be combined with one or a plurality of other desired characteristics from other embodiments, resulting in other embodiments not described in words or by reference to the drawings. Accordingly, such other embodiments fall within the framework of the scope of the appended claims.

What is claimed is:

1. A method of using clear ultra violet (UV) protective film for producing a pre-preg carbon fiber part comprising:
pre-applying a clear UV protective film to at least one of a top and bottom surface of a pre-preg carbon fiber workpiece;
placing the pre-preg carbon fiber workpiece between an upper mold portion and a lower mold portion of a hot press molding apparatus;
compressing the pre-preg carbon fiber workpiece between the upper and lower portions of the hot press molding apparatus to form a pre-preg carbon fiber part; and
holding the pre-preg carbon fiber part in the hot press molding apparatus until the pre-applied clear UV protective film and the pre-preg carbon fiber part have cured.

2. The method of claim 1 wherein the clear UV protective film is urethane based.

3. The method of claim 1 wherein the clear UV protective film is ionomer based.

4. The method of claim 1 wherein the clear UV protective film is fluoropolymer based.

5. The method of claim 1 wherein the clear UV protective film is polycarbonate based.

6. The method of claim 1 wherein the pre-preg carbon fiber part is a Class A surface part.

7. The method of claim 1 wherein the pre-preg carbon fiber workpiece is a dry lay up workpiece.

8. The method of claim 1 wherein the pre-preg carbon fiber workpiece is a wet lay up workpiece.

9. The method of claim 1 further comprising removing the pre-preg carbon fiber part from the hot press molding apparatus after curing is complete.

10. A method of using urethane based film for producing a pre-preg carbon fiber part comprising:
pre-applying a urethane based film to at least one of a top and bottom surface of a pre-preg carbon fiber workpiece;
placing the pre-preg carbon fiber workpiece between an upper mold portion and a lower mold portion of a hot press molding apparatus;
compressing the pre-preg carbon fiber workpiece between the upper and lower portions of the hot press molding apparatus to form a pre-preg carbon fiber part; and
holding the pre-preg carbon fiber part in the hot press molding apparatus until the pre-applied urethane based film and the pre-preg carbon fiber part have cured.

11. The method of claim 10 wherein the pre-preg carbon fiber part is a Class A surface part.

12. The method of claim 10 wherein the pre-preg carbon fiber workpiece is a dry lay up workpiece.

13. The method of claim 10 wherein the pre-preg carbon fiber workpiece is a wet lay up workpiece.

14. The method of claim 10 further comprising removing the pre-preg carbon fiber part from the hot press molding apparatus after curing is complete.
